(19) United States
(12) Patent Application Publication
(10) Pub. No.: US 2011/0158767 A1
(43) Pub. Date: Jun. 30, 2011

(54) REDUCED MATERIAL, CONTENT FASTENERS AND SYSTEMS AND METHODS FOR MANUFACTURING THE SAME

(75) Inventors: Terry Randall ELKINS, Scottsburg, IN (US); Kurt Vinton DUNAGAN, Madison, IN (US); Timothy Douglas BUSCHING, Madison, IN (US); David Wayne SWINGLE, Versailles, IN (US)

(73) Assignee: OHIO ROD PRODUCTS, Versailles, IN (US)

(21) Appl. No.: 12/648,658

(22) Filed: Dec. 29, 2009

(51) Int. Cl. F16B 35/04; B23P 15/00; G06F 19/00

(52) U.S. Cl. 411/424; 470/57; 700/148; 470/17

(57) ABSTRACT

Reduced material content fasteners are provided that have a reduced material content portion between working ends allowing the fastener to have less weight with equal or better break and torque strengths. Systems and methods are provided for manufacturing reduced material content fasteners that provide for cold working the initial material to reduce the material while work hardening the remaining material. The cold working is provided by rolls and/or dies.

### BACKGROUND OF THE INVENTION

This present invention generally pertains to fasteners, and systems and methods for making the same, that include a reduced material content area. More particularly, the present invention relates to reduced material content fasteners. The reduced material content fasteners, advantageously exhibiting minimum material volume, provide maximum workability of the fasteners, allowing for functionality comparable to that of traditionally manufactured fasteners in areas such as break strength, torque strength and engaging surface length. Systems and methods for manufacturing reduced material content fasteners are also provided.

### DESCRIPTION OF BACKGROUND ART

Swedged fasteners have desired features such as minimum material volume while providing fastening functions under specific parameters, and to provide a reduced cost. Swedged fasteners that are being driven into a material are easier to drive because there is less friction between the fastener and the material the fastener is driven into. While swedged fasteners are sought after, there are aspects in which improvement is sought. For example, there is a desire to provide a reduced material content area of a fastener with equal or better operating parameters than traditional fasteners. There is also a desire to have the reduced material content area of a fastener work hardened. There is further a desire to provide systems and methods to manufacture such desired reduced material content fasteners. There is an overall need to improve reduced material content fasteners and overcome the deficiencies of the prior art.

Prior art approaches include U.S. Pat. No. 2,060,593. This patent pertains to machine parts having a reduced shank portion with a reduced cross section. Every section of the machine part possesses the same load carrying capacity. The machine parts can be formed by cold working during shaping, a treatment step, such as heat-treating, after shaping, or a combination of the two. U.S. Pat. No. 2,356,686 describes a method of reducing the diameter of sections of cylindrical metallic bar stock by a cold swaging process followed by an annealing or heat-treating process. The swaged end portions are then screw-threaded.

U.S. Pat. No. 3,691,806 relates to a thread-rolling machine. Thread rolling cylindrical dies are paired with stationarily mounted rolling flat dies. Separate material rods are fed into the dies one at a time and the threads are rolled into the rods. U.S. Pat. No. 3,878,759 describes a self-thread forming fastener and a method for manufacturing the same. A first section of the fastener known as the holding section has a circular cross section. Another section of the fastener has a bi-lobular cross section. During manufacturing, thread forming die blanks continually engage the circular holding section of a blank to prevent slipping of the blank while the bi-lobular section is threaded.

Other prior art includes the following. U.S. Pat. No. 4,229,875 pertains to a fastener with improved fatigue characteristics. The threads are formed on the blank while the blank is under tension equal to the design load of the bolt being manufactured. Cold working can also be performed while the blank is under tension. U.S. Pat. No. 5,706,697 describes a process of ironing a thread formation on a bolt. A thread portion of the bolt is swaged to increase the diameter and then that portion is ironed to reduce the diameter. The portion is threaded in a later step.

With the present approach, it has been determined that various characteristics of prior art such as these patents and patent applications may have shortcomings and undesirable attributes, results or effects. The present approach recognizes and addresses matters such as these to provide enhancements not heretofore available. Overall, the present approach more fully meets the need to provide a reduced material content fastener. Furthermore, the present approach more fully meets the need to provide systems and methods for manufacturing reduced material content fasteners.

### SUMMARY OF THE INVENTION

An aspect or embodiment of the invention pertains to an improved reduced material content fastener that comprises a fastener, a reduced material content portion of the fastener and a work hardened portion of the fastener. The invention includes at least one section of the fastener that has reduced material content, allowing for reduced costs. For example, the reduced material content fastener can have a portion with a reduced cross-section having less material than an equivalent portion of a traditional fastener.

In accordance with another aspect or embodiment, the reduced material content fastener has features equivalent to traditional fasteners. The invention includes sections of the fastener that provide working features equivalent to working features of traditional fasteners. For example, a reduced material content fastener can include a hexagonal headed area at one end and threaded area at the other end equivalent to a traditional hex head threaded bolt, but with a reduced material content portion between the ends. The equivalent working features allow a reduced material content fastener to be substituted for the equivalent traditional fastener without the need for new tools or parts to work with the fasteners.

In still another aspect or embodiment, the reduced material content portion of a fastener is work hardened. Work hardening of the reduced material content portion of a fastener allows for providing equivalent operating parameters as compared to a traditional fastener. For example, the reduced material content portion of a fastener can be cold worked to provide equivalent break strength and torque strength as compared to a traditional fastener with a standard diameter throughout.

In another aspect or embodiment, manufacturing systems are provided to manufacture reduced material content fasteners. A manufacturing system can be a stand-alone system or it can be integrated into other systems for manufacturing fasteners. For example, a material volume reduction machine can be integrated into a manufacturing line between a wire drawer and a straightener with a cut off unit at the back end of the line.

In a further aspect or embodiment, manufacturing methods are provided to manufacture reduced material content fasteners. A manufacturing method can provide for continuous processing, batch processing, or a combination of continuous and batch processing to manufacture a quantity of reduced material content fasteners. For example, round wire stock can be drawn into rollers to produce an oval cross-section, after which the wire can be drawn into other rollers to produce a substantially circular cross-section that is smaller than the circular cross-section of the round wire stock, all in a continuous process.

It is the intention of at least one embodiment of the invention to provide a fastener including a shank having opposing ends and a reduced material content portion, at least one of the ends having a working portion, and wherein at least a portion of the reduced material content portion is work hardened.

In an aspect of the invention, an engagement portion is disposed on the working portion. In another aspect of the invention, the engagement portion is a head sized a shaped to be engaged by a tool. In yet another aspect of the invention, the engagement portion is sized and shaped to engage a surface. In another aspect of the invention, the engagement portion is threaded. In a further aspect of the invention, a portion of the reduced material content portion is work hardened by cold working. In yet another aspect of the invention, the reduced material content portion has a reduced grain size. In another aspect of the invention, the grain size is reduced transversely by about 21%. In a further aspect of the invention, the grain size is reduced longitudinally by about 15%. In yet another aspect of the invention, the reduced material content portion has an elongated grain structure. In another aspect of the invention, the grain structure is elongated by about 15%. In yet another aspect of the invention, the elongation of the fastener under load is reduced. In a further aspect of the invention, the elongation of the fastener under load is reduced by about 5-8%. In another aspect of the invention, the hardened reduced material content portion has a break strength at least equal to a break strength of an unreduced material content portion.

It is the intention of at least one embodiment of the invention to provide an apparatus for manufacturing a fastener including a material input portion, a material output portion, and a material reducing device having at least one material reducing assembly and at least one material work hardening assembly.

In an aspect of the invention, the material reducing assembly is the work hardening assembly. In another aspect of the invention, the material reducing assembly includes at least one material reducing member. In yet another aspect of the invention, the material reducing member is a roll. In another aspect of the invention, the material reducing member is a die. In a further aspect of the invention, the material reducing member is attached to a stationary mounting member. In yet another aspect of the invention, the material reducing member is attached to a movable mounting member. In another aspect of the invention, the movable mounting member is servomotor activated. In another aspect of the invention, the movable mounting member is hydraulically activated. In a further aspect of the invention, at least one material reducing member is attached to a stationary mounting member and at least one material educing member is attached to a movable mounting member. In another aspect of the invention, the first and second material reducing assemblies each include one roll attached to a stationary mounting member and one roll attached to a movable mounting member, wherein each roll is positioned perpendicularly to the feed direction of a material, and wherein the rolls of the first material reducing assembly are position perpendicularly to the rolls of the second material reducing assembly. In yet another aspect of the invention, the apparatus further includes a computer. In another aspect of the invention, the computer controls the movement of the rolls. In a further aspect of the invention, the apparatus further includes at least one of a straightening device, a caterpillar drive system, and a cut off machine, each controlled by the computer. In another aspect of the invention, the caterpillar drive system further includes a length sensor communicating with the computer. In yet another aspect of the invention, the caterpillar drive system further includes at least one V gripper. In another aspect of the invention, the V gripper includes first and second sections movably joined by at least one bolt, a V groove in the first section, and a wave spring between the firs and second sections.

It is the intention of at least one embodiment of the invention to provide a method for manufacturing a fastener including inputting a material into a material reducing device, engaging a portion of the input material by at least one material reducing assembly, working the engaged portion of input material by at least one material reducing member of the material reducing assembly to provide at least one of, reducing the amount of material in the engaged portion, hardening the material in the engaged portion, and changing the cross-section of the material in the engaged portion, and outputting the worked material from the material reducing assembly.

In an aspect of the invention, hardening the material in the engaged portion is by at least one of work hardening, heat-treating and annealing. In a further aspect of the invention, the material reducing member changes a substantially circular cross section of the input material to a substantially oval cross section. In another aspect of the invention, the method includes further engaging a portion of the worked material from a first material reducing assembly by a second material reducing assembly, reworking the further engaged portion of worked material by at least one material reducing member of the second material reducing assembly to provide at least one of, reducing the amount of worked material in the further engaged portion, hardening the material in the further engaged portion, and changing the cross-section of the further engaged portion, and outputting the reworked material from the second material reducing assembly. In another aspect of the invention, hardening the material in the further engaged portion is by at least one of work hardening, heat-treating and annealing. In another aspect of the invention, the first material reducing assembly changes the input material having a substantially circular cross section to the worked material having a substantially oval cross section. In a further aspect of the invention, the second material reducing assembly changes the worked material having the substantially oval cross section to the reworked material having a substantially circular cross section smaller than the input material. In another aspect of the invention, a computer controls movement of the input material, the worked material, the reworked material, the output material and the material reducing members. In yet another aspect of the invention, the movement of the input material, the worked material, the reworked material, and the output material are facilitated by a caterpillar drive system. In another aspect of the invention, the manufacturing method further includes outputting the reworked material to a straightening device controlled by the computer, communicating material parameters from a length sensor to the computer, and feeding output material from the straightening device to a cut off device controlled by the computer.

### BRIEF DESCRIPTION OF THE DRAWINGS

FIG. 1 is a front elevation view of an embodiment of a reduced material content fastener;

FIG. 2 is a front elevation view of another embodiment of a reduced material content fastener;

FIG. 3 is a front elevation view of another embodiment of a reduced material content fastener;

FIG. 4 is a front elevation view of another embodiment of a reduced material content fastener;

FIG. 5 is a front elevation view of another embodiment of a reduced material content fastener;

FIG. 6 is a front elevation view of an embodiment of a material reducing device;

FIG. 7 is a front elevation view of another embodiment of a material reducing device;

FIG. 8 is a front elevation view of another embodiment of a material reducing device;

FIG. 9 is a front elevation view of a portion of an embodiment of a material reducing assembly;

FIG. 10 is a side view of the material reducing assembly of FIG. 9;

FIG. 11 is a front elevation view of an embodiment of a material reducing assembly;

FIG. 12 is a front elevation view of an embodiment of a manufacturing line;

FIG. 13 is a diagrammatic view of an embodiment of a reduced material content fastener manufacturing method;

FIG. 14 is a magnified transverse cross-sectional view of an embodiment of a reduced material content fastener;

FIG. 15 is a magnified transverse cross-sectional view of an embodiment of a typical fastener;

FIG. 16 is magnified longitudinal cross-sectional view of an embodiment of a reduced material content fastener; and

FIG. 17 is a magnified longitudinal cross-sectional view of an embodiment of a typical fastener.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

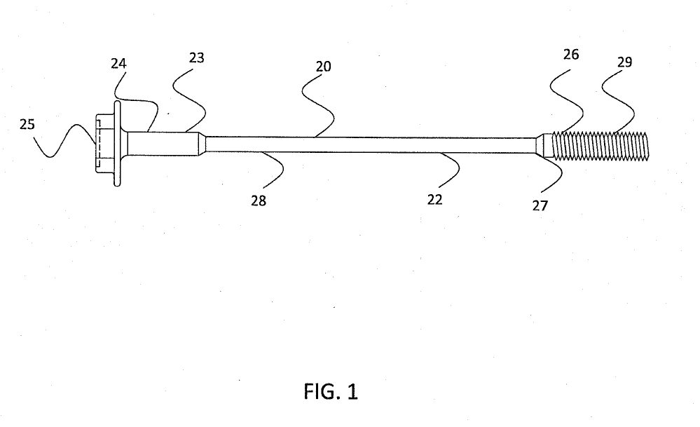

FIG. 1 illustrates an embodiment of a reduced material content fastener generally designated as 20. The illustrated embodiment of FIG. 1 is a headed bolt or screw. Reduced material content fastener 20 has a shank 22 having a first end 24, a second end 26, and a reduced material content portion 28. Reduced material content fastener 20 can be made from any industry standard material such as steel, pregalvanized steel, stainless steel, aluminum or brass for example. First end 24 has a first working portion 23 and a first engagement portion 25. Second end 26 has a second working portion 27 and a second engagement portion 29. First and second engagement portions 25, 29 can be sized and shaped to provide engagement surfaces such as heads, collars or threads for example. Heads can be configured to be driven by Square drive, Apex, Allen, Star drive, Six Lobe or ORP drive tools, as well as any other drive tools. First and second engagement portions 25, 29 can be engaged by force exerting members (not shown) such as fingers, wrenches, nut drivers, and screwdrivers for example. Alternatively, first and second engagement portions 25, 29 can engage a surface such as a nut, a threaded bore or a solid material such as wood or concrete. Reduced material content portion 28 has a cross section that is smaller than the largest cross section of each of the first and second working portions 23, 27. A portion of reduced material content portion 28 is hardened by any known process such as cold working, annealing or heat-treating for example. The break strength and torque strength of reduced material content portion 28 are equal to or greater than the break strength and torque strength of a typical fastener that does not have a reduced material content portion. Alternatively, the break strength and torque strength of reduced material content portion 28 can be less than that of a typical fastener, such as for use in breakaway, controlled torque, or controlled break strength fasteners for example.

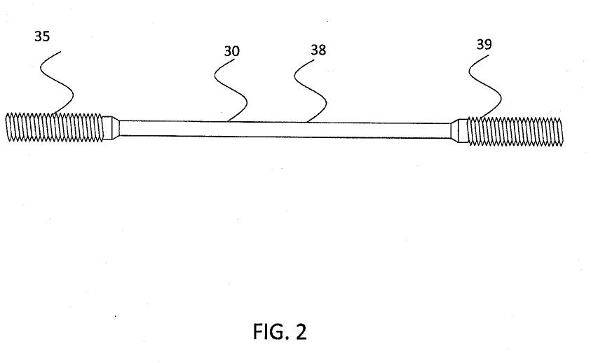

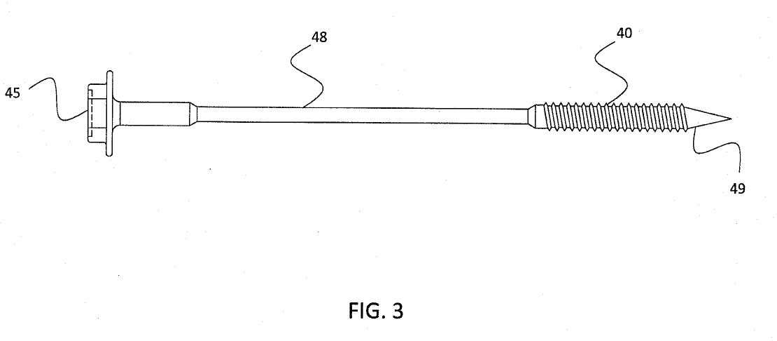

FIGS. 2-5 illustrate other embodiments of reduced material content fasteners. For example, the illustrated embodiment of FIG. 2 is a reduced material content fastener 30 shown as a double-ended stud with a reduced material content portion 38. Alternatively, the reduced material content fastener 30 can be a single ended stud. First and second engagement portions 35, 39 are threaded stud ends. FIG. 3 illustrates an embodiment of a reduced material content fastener 40 shown as a headed self-tapping bolt or screw. First engagement portion 45 is a head and second engagement portion 49 is a tapping screw thread. A reduced material content portion 48 is between first and second engagement portions 45, 49. Reduced material content portion 48 lowers the driving torque required to drive reduced material content fastener 40 because the larger cross-section of threaded second engagement portion 49 opens a hole that the reduced material content portion 48 moves through, thereby minimizing material, such as wood for example, from clamping down on the shank of the fastener. For example, when putting two boards together, reduced material content fastener 40 allows the headed first engagement portion 45 to pull the first board down against the second board as the reduced material content fastener 40 is driven into the boards.

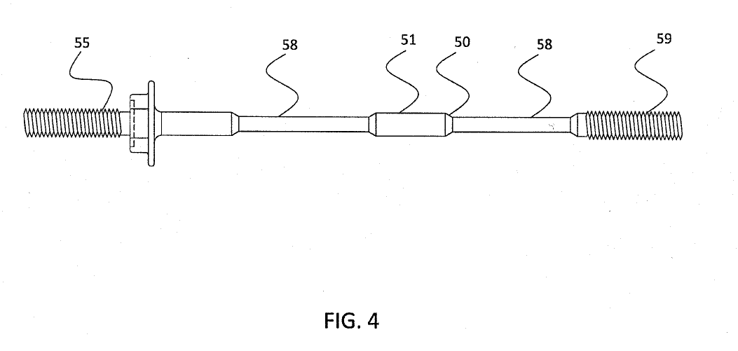

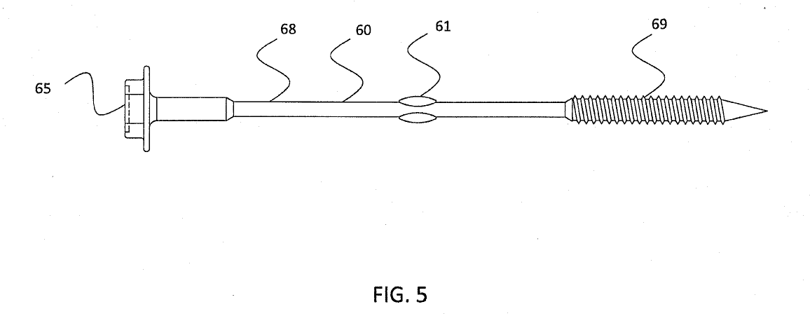

A reduced material content fastener 50 illustrated in FIG. 4 is shown as a headed and threaded bolt screw or threaded stud. Reduced material content fastener 50 has multiple reduced material content portions 58. First engagement portion 55 is both threaded and headed while second engagement portion 59 is threaded. A center engagement portion 51 has undercuts 53 that are adjacent to reduced material content portions 58. Undercuts 53 can provide gripping surfaces to prevent reduced material content fastener 50 from pulling out of a material. For example, a portion of reduced material content fastener 50 can have a material poured around it such that the material fills in around at least one undercut 53, thereby providing a gripping surface against the material and preventing reduced material content fastener 50 from being pulled out of the material when the head of first engagement portion 55 is tightened. The material can be concrete, plastic, plaster or fiberglass for example. FIG. 5 illustrates an embodiment of a reduced material content fastener 60 shown as a logster. The reduced material content portion 68 is shown between a headed first engagement portion 65 and a self-tapping threaded second engagement portion 69.

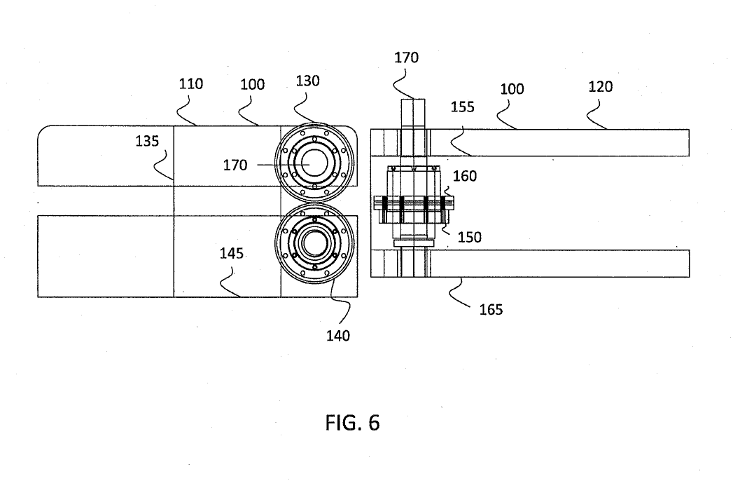

FIG. 6 illustrates an embodiment of a material reducing device generally designated as 100. Material reducing device 100 includes at least a first material reducing assembly 110 having at least a first material reducing member 130. The illustrated embodiment includes first material reducing assembly 110 and a second material reducing assembly 120. First material reducing assembly 110 includes first material reducing member 130 and a second material reducing member 140. Second material reducing assembly 120 includes a third material reducing member 150 and a fourth material reducing member 160. Material reducing members 130, 140, 150, 160 can be any known material working member such as a roll or a die for example. Material reducing members 130, 140, 150, 160 as illustrated are rolls attached to mounting members that can be stationary or movable. Material reducing members 130, 140, 150, 160 can be easily removed and changed out as desired. For example, material reducing members that have different characteristics can be quickly changed to set up a material reducing process for a different type of reduced material content fastener, allowing for minimal down time of the production line.

The illustrated embodiment of FIG. 6 includes first and fourth mounting members 135, 165 that are stationary and second and third mounting members 145, 155 that are movable. Material reducing members 130, 140, 150, 160 are attached to mounting members 135, 145, 155, 165 by an attachment member 170. Attachment member 170 can be any known attachment member such as an axle, a bearing or an arm for example. The illustrated embodiment includes an attachment member 170 that is a double roller bearing.

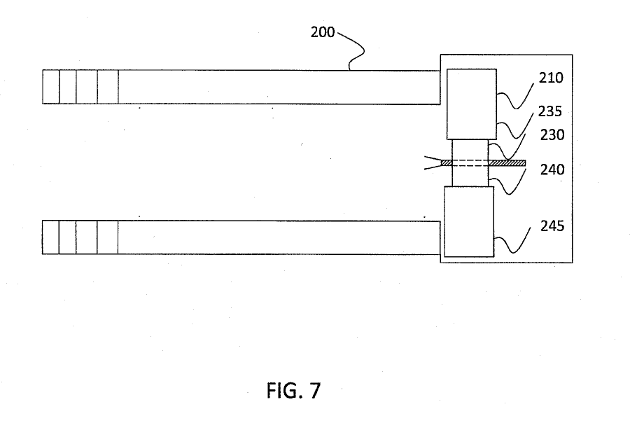

FIG. 7 illustrates an embodiment of a material reducing device 200 having a material reducing assembly 210. Material reducing assembly 210 includes a first material reducing member 230 connected to a first mounting member 235 and a second material reducing member 240 connected to a second mounting member 245. In the illustrated embodiment, first mounting member 235 is slidably movable and second mounting member 245 is stationary, and first and second reducing members 230, 240 are dies.

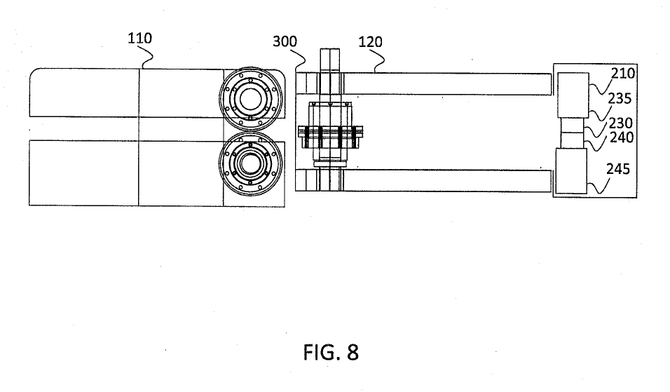

Another illustrated embodiment combines material reducing devices 100 and 200 to provide material reducing device 300, as seen in FIG. 8. Material reducing device 300 includes first and second material reducing assemblies 110, 120 and material reducing assembly 210. Alternatively, any number of material reducing assemblies in any configuration can be combined to provide a desired material reducing device.

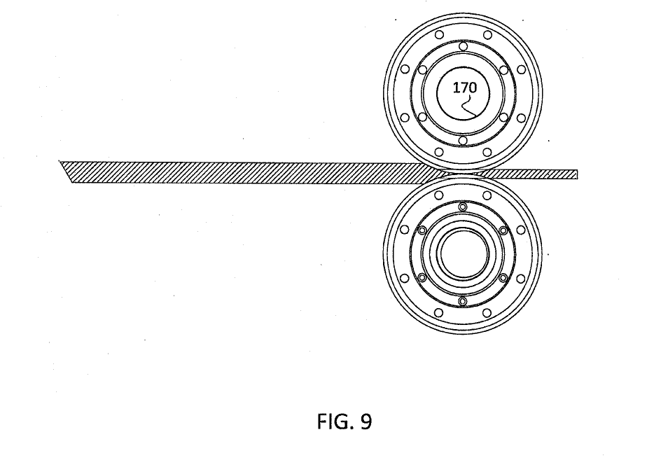

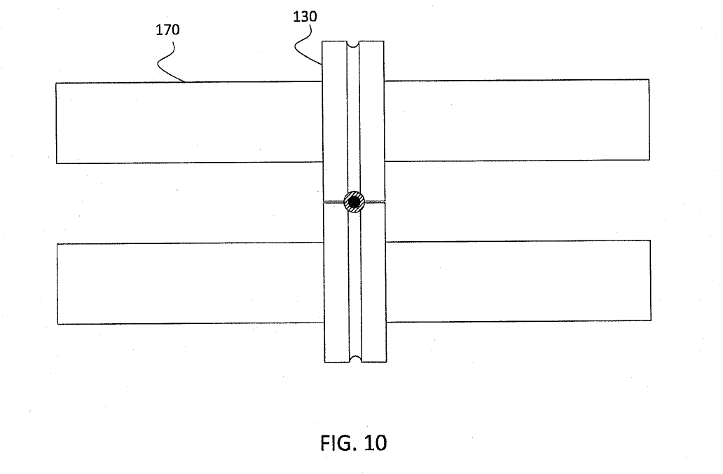

FIGS. 9 and 10 illustrate an input material 80 being worked by material reducing members 130, 140. Input material 80 can be any known material such as a continuous feed metal wire stock that is worked on in a continuous manufacturing process for example. Alternatively, input material 80 can be discrete metal blanks that are fed in a continuous process from a hopper for example. Input material 80 can also be worked on in a batch process. Input material 80 can be fed or pushed into material reducing members 130, 140, or input material 80 can be drawn or pulled through material reducing members 130, 140. Input material 80 can have any known cross sectional shape, such as a circle, a square, a hexagon, an octagon or an oval for example. The cross sectional shape of the illustrated input material 80 is an oval for example. Material reducing members 130, 140 rotate and work input material 80 to reduce its material volume, thereby producing a worked material 85. Worked material 85 has a different cross sectional size and/or shape than that of input material 80. The cross sectional shape of worked material 85 can be any shape, such as a circle, a square, a hexagon, an octagon or an oval for example. As seen in FIG. 10, the illustrated worked material 85 has a circular cross section. Worked material 85 can be in the desired final state or it can be input into another device such as another material reducing assembly, a threading machine, a straightening device or a cut off machine for example.

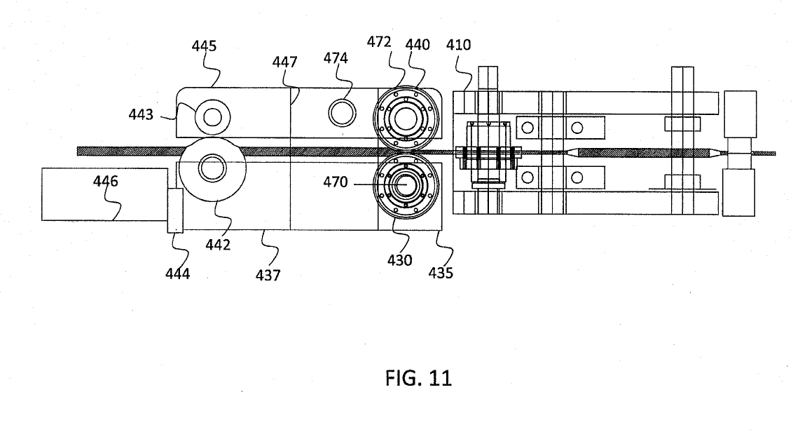

FIG. 11 illustrates an embodiment of a material reducing assembly generally designated 410. Material reducing assembly 410 includes first and second material reducing members 430, 440. First material reducing member 430 is connected to a first mounting member 435 by a first attachment member 470. First mounting member 435 is stationary and is fixedly attached to a stationary back plate 437. Second material reducing member 440 is attached to a second mounting member 445 by a second attachment member 472. Second mounting member 445 is attached to a pivot member 447 by a third attachment member 474. Second mounting member 445 is pivotally movable about the axis of third attachment member 474, allowing second material reducing member 440 to be positioned as desired relative to first material reducing member 430. Alternatively, second material reducing member 430 can be attached to other movable mounting members such as a slide plate or a press member for example. A driving portion 443 of second mounting member 445 engages a driving member 442. Driving member 442 can be a cam, a lever, a press member or a pull rod for example. The illustrated driving member 442 is a cam that is mounted to a gear box 444 and driven by a servomotor 446. Alternatively, driving member 442 can be mounted to a movable plate, an arm or a lever and be driven by an actuator, a hydraulic press or a manual lever for example. Driving member 442 can be controlled by a control device (not shown) such as a computer, a programmable logic controller (PLC) or an operator interface for example.

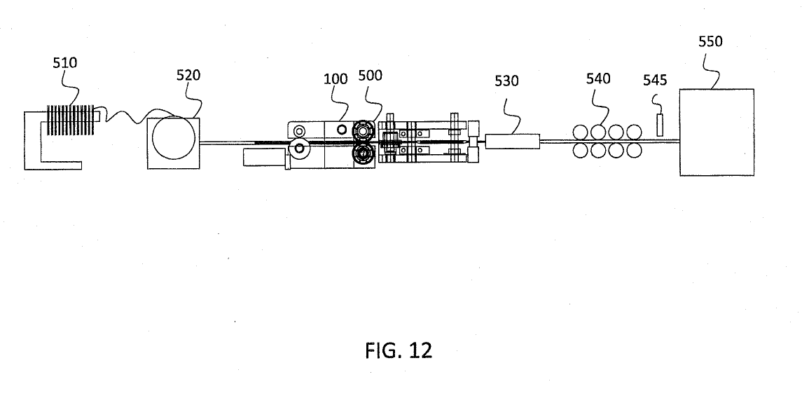

As shown in FIG. 12, material reducing device 100, 200, 300 can be part of a manufacturing line 500. Alternatively, Manufacturing line 500 can include any machine, device or member desired to work upon or engage a material. In the illustrated embodiment, manufacturing line 500 includes a static unwind stand 510, a wire drawer 520, material reducing device 100, a straightener 530, a caterpillar drive system 540, and a finishing device 550. Finishing device 550 can be any desired machine or device such as a threading machine, a bending machine, or a cut off machine for example. Caterpillar drive system 540 can include a sensor 545. Sensor 545 can be any desired sensor such as a length sensor for example. Sensor 545 can provide information to material reducing device 100 and/or finishing device 550 for example. Sensor 545 can provide such information as when to raise and lower the material reducing members, when to cut off the material, the speed of the material movement and length measurements of the material for example.

A material reducing device such as material reducing device 100 can be operated to produce a reduced material content fastener such as reduced material content fastener 30. First material reducing member 130 is moved to a desired position for working input material 80. Input material 80 with a circular cross section is drawn into first material reduction assembly 110 and is engaged by first and second material reducing members 130, 140. First and second material reducing members 130, 140 cold roll input material 80 to change input material 80 with a circular cross section to worked material 85 with an oval cross section. Third material reducing member 150 is moved into a desired position for working worked material 85. Worked material 85 is drawn into material reducing assembly 120 and is engaged by third and fourth material reducing members 150, 160. Third and fourth material reducing members 150, 160 cold roll worked material 85 to change worked material 85 with an oval cross section to reworked material 90 with a substantially circular cross section. The substantially circular cross section of reworked material 90 is smaller than the circular cross section of input material 80. The cold rolling process of first material reducing assembly 110 and/or second material reducing assembly 120 serves to provide simultaneous cold working of input material 80 and/or worked material 85 to harden the reduced material content portion 38. Alternatively, worked material 85 and/or reworked material 90 can be hardened by a separate process such as heat treating or annealing, or the hardening process can involve a combination of cold working and another process for example. Reworked material 90 is then drawn out of material reducing device 100 and further manufactured, stored or moved as desired. Alternatively, reworked material 90 could be further worked in additional processes within material reducing device 100. In this example, reworked material 90 is further manufactured by a threading machine that puts threads onto first and second engagement portions 35, 39 and a cut off machine that cuts reworked material 90 at both ends, resulting in a double ended threaded stud. Input material 80, worked material 85 and reworked material 90 can each optionally have any desired cross-sectional area, such as circular, oval, square, rectangular, pentagonal, hexagonal or octagonal for example.

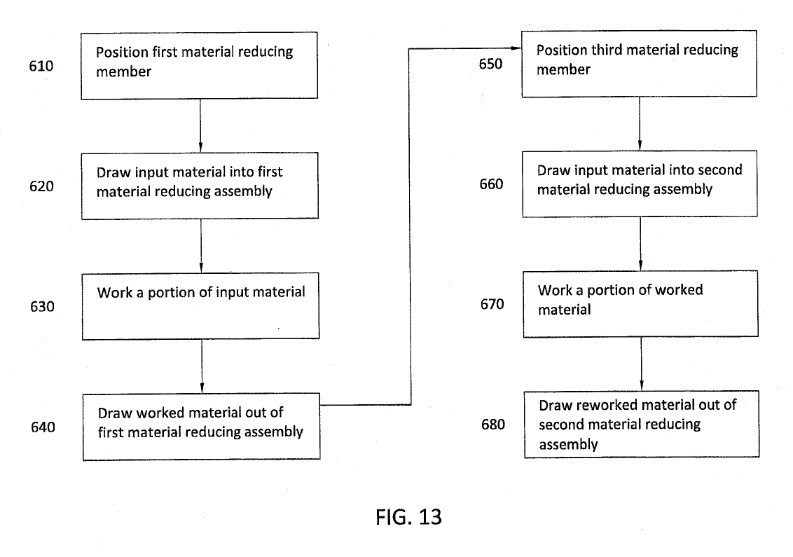

FIG. 13 illustrates a reduced material content fastener manufacturing method 600 using a block diagram. A first positioning step 610 moves a first material reducing member 130 into a desired position. A first drawing step 620 draws input material 85 into first material reducing assembly 110. Input material 80 is worked by first and second material reducing members 130, 140 in a first working step 630. A second drawing step 640 draws the resulting reworked material 85 out of first material reducing assembly 110. Third material reducing member 150 is moved into a desired position in a second positioning step 650. A third drawing step 660 draws worked material 85 into second material reducing assembly 120. Worked material 85 is reworked by third and fourth material reducing members 150, 160 in a second working step 670. A fourth drawing step 680 draws reworked material 90 out of second material reducing assembly 120.

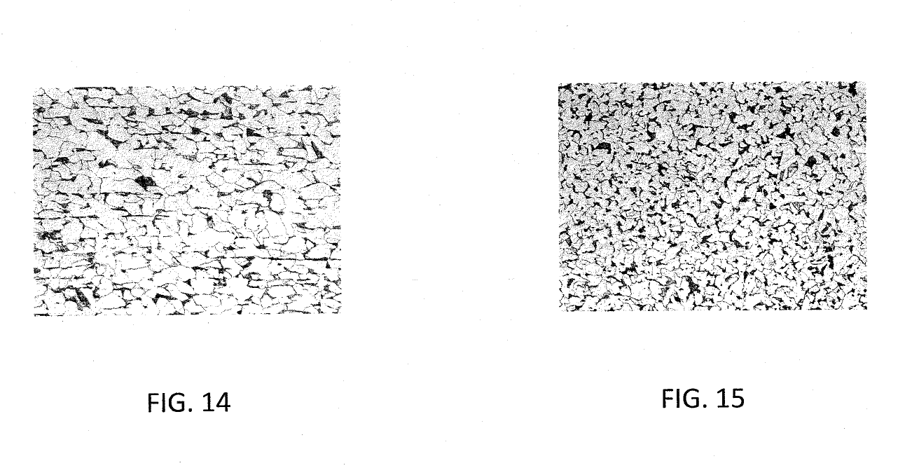

FIGS. 14 and 15 are magnified 500× and illustrate the grain size and grain refinement from a transverse cross-sectional perspective for an embodiment of a reduced material content fastener of the present invention and a typical fastener respectively. Using ASTM E112-96, the grain size of the illustrated reduced material content fastener can be evaluated to be about 11.5 and the grain size of the illustrated typical fastener can be evaluated to be about 10.5, for example. The 1.0 finer grain size of the illustrated reduced material content fastener represents a grain area that is about 21% smaller than that of the illustrated typical fastener, for example.

This grain refinement is due to cold working the material volume reduced section of a reduced material content fastener according to the present invention. The cold working work hardens and refines the steel grain structure, increasing the tensile strength, allowing the crossectional area to be reduced, maintaining the same product break strength, and increasing the tensile strength when calculated versus the crossectional area or PSI. During this refinement, the grain cell attachments to the surrounding grain cells are strengthened. The finer grain and strengthened attachment requires higher forces to separate a grain from surrounding grains, causing the resulting steel microstructure to be stronger by having a higher tensile strength and a higher column strength.

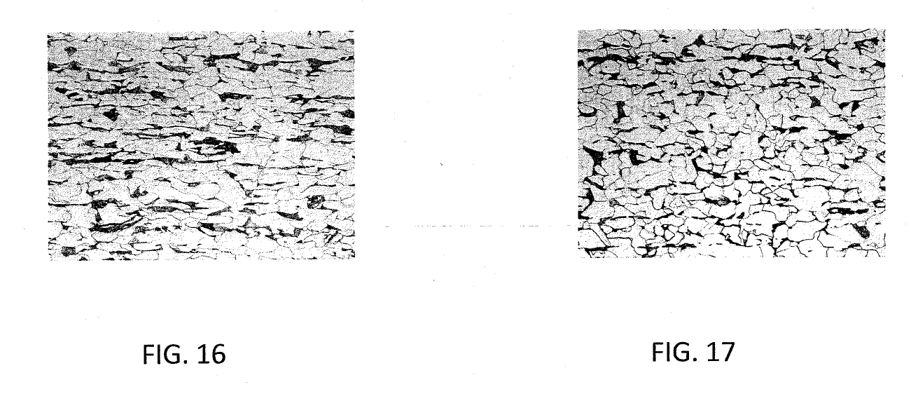

FIGS. 16 and 17 are magnified 500× and illustrate the grain size and grain refinement from a longitudinal cross-sectional perspective for an embodiment of a reduced material content fastener of the present invention and a typical fastener respectively. Using ASTM E112-96, the grain size of the illustrated reduced material content fastener can be evaluated to be about 11.0 and the grain size of the illustrated typical fastener can be evaluated to be about 10.5, for example. The 0.5 finer grain size of the illustrated reduced material content fastener represents a grain area that is about 15% smaller than that of the illustrated typical fastener, for example. However, the grain structure of the illustrated reduced material content fastener is stretched and is oriented about 15% longer than the grain structure of the illustrated typical fastener, for example.

This grain refinement and grain structure orientation is due to cold working the material volume reduced section of a reduced material content fastener according to the present invention. The cold working actually work hardens and refines/orients the steel grain structure, increasing the tensile strength, allowing the crossectional area to be reduced, maintaining the same product break strength, and increasing the tensile strength when calculated versus the crossectional area or PSI. During this refinement and orientation the grain structure alignment is streamlined. This grain structure alignment allows the product to elongate about 5-8% less under load, and have higher tensile and column strength when put under tensile loading, for example. Therefore, the finer, more elongated, more aligned, and more oriented grain structure of the illustrated reduced material content fastener provides for higher tensile strength, higher yield strength, lower elongation, and higher column strength, allowing a reduced material volume having the same or better break strength than the illustrated typical fastener.

A preferred fastener embodiment of the invention is reduced material content fastener 20 provided as a headed and threaded bolt or screw. Reduced material content fastener 20 has reduced material content portion 28 of shank 22 between first engagement portion 25 that has a headed area and second engagement portion 29 that has a threaded area. Reduced material content portion 28 has a smaller cross sectional area than the cross sectional areas of first and second working portions 23, 27. Reduced material content portion 28 is hardened such that the break and torque strengths of material portion 28 are equal to or greater than the break and torque strengths of first and second working portions 23, 27.

An optional embodiment of the invention is reduced material content fastener 30 provided as a single or double ended stud. Reduced material content fastener 30 has reduced material content portion 38 between first engagement portion 35 that has a threaded area and second engagement portion 39 that has a threaded area. First engagement portion 35 can optionally be unthreaded and have a smooth surface or a textured surface for example.

Another optional embodiment of the invention is reduced material content fastener 40 provided as a headed self tapping bolt or screw. Reduced material content fastener 40 has reduced material content portion 48 between first engagement portion 45 that has a headed area and second engagement portion 49 that has a pointed and threaded area.

A further optional embodiment of the invention is reduced material content fastener 50 provided as a headed and threaded bolt screw with multiple reduced material content portions 58. Reduced material content fastener 50 has reduced material content portions 58 between first engagement portion 55 that has a headed area and second engagement portion 59 that has a threaded area. A non-reduced material content area 51 is between reduced material content portions 58. Alternatively, first engagement area 55 can be a threaded area instead of a headed area or first engagement area 55 can be both headed and threaded.

Another optional embodiment of the invention is reduced material content fastener 60 provided as an ORP logster. Reduced material content fastener 60 has reduced material content portion 68 between first engagement portion 65 that has a headed area and second engagement portion 69 that has a pointed and threaded area. A portion of reduced material content portion 68 has raised bumps 61.

A preferred device embodiment of the invention is material reducing device 100, including first and second material reducing assemblies 110, 120 having first and second material reducing members 130, 140 and third and fourth material reducing members 150, 160 respectively. First, second, third and fourth material reducing members are attached to first, second, third and fourth mounting members 135, 145, 155, 165 respectively. First and third mounting members 135, 155 are movable and second and fourth mounting members 145, 165 are stationary. First and third mounting members 135, 155 are pivotally mounted to pivoting members 447 and engage cams 442 driven by servo motors 446 coupled with gear boxes 444.

An optional embodiment of the invention is material reducing device 200 including material reducing assembly 210 having first and second material reducing members 230, 240 that are dies. Material reducing member 230 is attached to movable first mounting member 235 and material reducing member 240 is attached to stationary second mounting member 245.

Another optional embodiment of the invention is material reducing device 300 that is a combination of material reducing devices 100 and 200.

A preferred embodiment of the invention for a method of manufacturing a reduced material content fastener is reduced material content fastener manufacturing method 600 using preferred reduced material content device 100. First positioning step 610 moves first material reducing member 130 into position after which a first drawing step 620 draws input material 80 having a circular cross section into first material reducing assembly 110. A first working step 630 brings first and second material reducing members 130, 140 into engagement with input material 80 and cold rolling a portion of input material 80 into worked material 85 having an oval cross section. The cold rolling process simultaneously cold works the cold rolled portion of input material 80 to harden reworked material 85. A second drawing step 640 draws reworked material 85 out of first material reducing assembly 110 and a second positioning step 650 then moves third material reducing member 150 into position. A third drawing step 660 draws reworked material 85 into second material reducing assembly 120 and a second working step 670 engages third and fourth material reducing members 150, 160 with worked material 85 and cold rolling a portion of worked material 85 into reworked material 90 having a substantially circular cross section smaller than the circular cross section of input material 80. The cold rolling process simultaneously cold works the cold rolled portion of worked material 85 to further harden reworked material 90. A fourth drawing step 680 draws reworked material 90 out of second material reducing assembly 120.

An optional embodiment of the invention for a method of manufacturing a reduced material, content fastener utilizes material reducing device 200 instead of material reducing device 100.

Another optional embodiment of the invention for a method of manufacturing a reduced material content fastener utilizes material reducing device 300 instead of material reducing device 100.

It will be understood that there are numerous modifications of the illustrated embodiments described above which will be readily apparent to one skilled in the art, such as variations and modifications of the material reducing system and/or its components including combinations of features disclosed herein that are individually disclosed or claimed herein, explicitly including additional combinations of such features, or alternatively other types of material reducing systems. For example, material reducing systems can have shaping rollers that are stationary or sliding, as well as a split die if desired. Also, there are many possible variations in the materials and configurations. These modifications and/or combinations fall within the art to which this invention relates and are intended to be within the scope of the claims, which follow.

1. A fastener, comprising:
a shank having opposing ends and a reduced material content portion;
at least one of the ends having a working portion; and
wherein at least a portion of the reduced material content portion is hardened.

2. The fastener of claim 1, further comprising an engagement portion disposed on the working portion.

3. The fastener of claim 2, wherein the engagement portion is a head sized and shaped to be engaged by a tool.

4. The fastener of claim 1, wherein the engagement portion is sized and shaped to engage a surface.

5. The fastener of claim 1, wherein the engagement portion is threaded.

6. The fastener of claim 1, wherein a portion of the reduced material content portion is work hardened by cold working.

7. The fastener of claim 6, wherein the reduced material content portion has a reduced grain size.

8. The fastener of claim 7, wherein the grain size is reduced transversely by about 21%.

9. The fastener of claim 7, wherein the grain size is reduced longitudinally by about 15%.

10. The fastener of claim 6, wherein the reduced material content portion has an elongated grain structure.

11. The fastener of claim 10, wherein the grain structure is elongated by about 15%.

12. The fastener of claim 6, wherein the elongation of the fastener under load is reduced.

13. The fastener of claim 12, wherein the elongation of the fastener under load is reduced by about 5-8%.

14. The fastener of claim 1, wherein the hardened reduced material content portion has a break strength at least equal to a break strength of an unreduced material content portion.

15. An apparatus for manufacturing a fastener, comprising:
a material input portion;
a material output portion; and
a material reducing device comprising at least one material reducing assembly and at least one work hardening assembly.

16. The apparatus of claim 15, wherein the material reducing assembly is the work hardening assembly.

17. The apparatus of claim 15, wherein the material reducing assembly is comprised of at least one material reducing member.

18. The apparatus of claim 17, wherein the material reducing member is a roll.

19. The apparatus of claim 17, wherein the material reducing member is a die.

20. The apparatus of claim 17, wherein the material reducing member is attached to a stationary mounting member.

21. The apparatus of claim 17, wherein the material reducing member is attached to a movable mounting member.

22. The apparatus of claim 21, wherein the movable mounting member is servomotor activated.

23. The apparatus of claim 21, wherein the movable mounting member is hydraulically activated.

24. The apparatus of claim 17, wherein at least one material reducing member is attached to a stationary mounting member and at least one material reducing member is attached to a movable mounting member.

25. The apparatus of claim 15, wherein first and second material reducing assemblies each comprising one roll attached to a stationary mounting member and one roll attached to a movable mounting member, wherein each roll is positioned perpendicularly to the feed direction of a material, and wherein the rolls of the first material reducing assembly are position perpendicularly to the rolls of the second material reducing assembly.

26. The apparatus of claim 15, further comprising a computer.

27. The apparatus of claim 26, further comprising a computer wherein the computer controls the movement of the rolls.

28. The apparatus of claim 27, further comprising at least one of a straightening device, a caterpillar drive system, and a cut off machine, each controlled by the computer.

29. The apparatus of claim 28, wherein the caterpillar drive system further comprises a length sensor communicating with the computer.

30. The apparatus of claim 29, wherein the caterpillar drive system further comprises at least one V gripper.

31. The apparatus of claim 30, wherein the V gripper comprises first and second sections movably joined by at least one bolt, a V groove in the first section, and a wave spring between the first and second sections.

32. A method for manufacturing fasteners, comprising:
inputting a material into a material reducing device;
engaging a portion of the input material by at least one material reducing assembly;
working the engaged portion of input material by at least one material reducing member of the material reducing assembly to provide at least one of, reducing the amount of material in the engaged portion, hardening the material in the engaged portion, and changing the cross-section of the material in the engaged portion; and
outputting the worked material from the material reducing assembly.

33. The method of claim 32, wherein hardening the material in the engaged portion is by at least one of work hardening, heat-treating and annealing.

34. The method of claim 32, wherein the material reducing member changes a substantially circular cross section of the input material to a substantially oval cross section.

35. The method of claim 32, further comprising:
further engaging a portion of the worked material from a first material reducing assembly by a second material reducing assembly;
reworking the further engaged portion of worked material by at least one material reducing member of the second material reducing assembly to provide at least one of, reducing the amount of worked material in the further engaged portion, hardening the material in the further engaged portion, and changing the cross-section of the further engaged portion; and
outputting the reworked material from the second material reducing assembly.

36. The method of claim 35, wherein hardening the material in the further engaged portion is by at least one of work hardening, heat-treating and annealing.

37. The method of claim 35, wherein the first material reducing assembly changes the input material having a substantially circular cross section to the worked material having a substantially oval cross section.

38. The method of claim 37, wherein the second material reducing assembly changes the worked material having the substantially oval cross section to the reworked material having a substantially circular cross section smaller than the input material.

39. The method of claim 35, wherein a computer controls movement of the input material, the worked material, the reworked material, the output material and the material reducing members.

40. The method of claim 39, wherein the movement of the input material, the worked material, the reworked material, and the output material are facilitated by a caterpillar drive system.

41. The method of claim 40, further comprising:
outputting the reworked material to a straightening device controlled by the computer;
communicating material parameters from a length sensor to the computer; and
feeding output material from the straightening device to a cut off device controlled by the computer.
